(19) United States
(12) Patent Application Publication
(10) Pub. No.: US 2008/0003479 A1
(43) Pub. Date: Jan. 3, 2008

(54) IONIC POLYMER METAL COMPOSITE ELECTROLYTE FOR FUEL CELL

(75) Inventors: Young Soo YOON, Gyeonggi-do (KR); Hoon Chel PARK, Seoul (KR); Gwang Joon YOON, Seoul (KR); Seung Hyun JEE, Gyeonggi-do (KR)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(73) Assignee: KONKUK UNIVERSITY INDUSTRIAL COOPERATION CORP., Seoul (KR)

(21) Appl. No.: 11/676,549

(22) Filed: Feb. 20, 2007

(30) Foreign Application Priority Data
Jun. 29, 2006 (KR) 10-2006-0059143

(51) Int. Cl. H01M 8/10

(52) U.S. Cl. 429/33

(57) ABSTRACT

Disclosed are an ionic polymer metal composite electrolyte for a fuel cell and a method of preparing the same. In detail, the invention provides an ionic polymer metal composite electrolyte for a fuel cell, in which an ionic polymer metal composite, in which platinum nanoparticles are dispersed in a Nafion membrane, is used as an electrolyte, in place of the Nafion membrane alone, upon the fabrication of a fuel cell having a polymer electrolyte, and also provides a method of preparing the same. The ionic polymer metal composite electrolyte of the invention can solve problems related to the cross-over of a conventional Nafion membrane, and thereby can be used as the polymer membrane of a methanol direct fuel cell, having improved open-circuit voltage.

### BACKGROUND OF THE INVENTION

1. Field of the Invention

The present invention relates, generally, to an ionic polymer metal composite electrolyte for a fuel cell and a method of preparing the same. More particularly, the present invention relates to an ionic polymer metal composite electrolyte for a fuel cell, in which an ionic polymer metal composite (IPMC), in which platinum nanoparticles are dispersed in a conventional Nafion membrane, is used as an electrolyte, in place of the Nafion membrane alone, upon the fabrication of a fuel cell having a polymer electrolyte, and to a method of preparing the same.

2. Description of the Related Art

In general, fuel cells are a kind of generator for directly converting chemical energy in fuel into electrical energy. Specific examples of fuel cells using a polymer electrolyte include a proton exchange membrane fuel cell (PEMFC) and a direct methanol fuel cell (DMFC).

The PEMFC is advantageous because it has a lower operating temperature, higher energy conversion efficiency, greater current density and output density, and more rapid response properties with respect to changes in load, compared to other fuel cells. In particular, the PEMFC adopts a polymer membrane as an electrolyte, and thus the structure thereof is simple. Further, since corrosion is not a consideration, selection can be made from among a wide variety of materials. Therefore, the PEMFC is applicable to various industrial fields.

In such a PEMFC, a Nafion membrane (Nafion®), which is available from DuPont and is a tetrafluoroethylene copolymer containing perfluorosulfonic acid in the side chain thereof, is used as the electrolyte. However, the Nafion membrane is disadvantageous because it should be sufficiently humidified for efficient operation, and should also be used at temperatures not higher than 80° C., in order to prevent the loss of moisture. Furthermore, the carbon-carbon bond of the main chain of the Nafion membrane is attacked by oxygen, and thus the membrane becomes unstable under conditions in which the fuel cell is operated.

In addition, in the case of the DMFC, an aqueous methanol solution is supplied to an anode as fuel. However, part of unreacted methanol permeates into the polymer electrolyte membrane, and the methanol permeated into the polymer electrolyte membrane diffuses up to the catalyst layer of a cathode while causing a phenomenon of swelling the electrolyte membrane. This phenomenon is referred to as methanol cross-over. In the cathode, in which the electrochemical reduction of hydrogen ions and oxygen should progress, methanol causes direct oxidation, and thus the potential of the cathode is decreased, thereby seriously deteriorating cell performance.

As a result, the theoretical potential based on movement of hydrogen ions between the anode and the cathode is about 1.2 V, but the open-circuit voltage of the DMFC, using a Nafion membrane, is decreased to about 0.8 V due to cross-over.

Such a phenomenon results in a decrease in the amount of energy that is obtainable from the fuel cell in practice. Thus, assuming that the number of electrons occurring in the anode, that is, the amount of current, is the same, total energy, which is determined to be W=VI, may be increased by as high as ΔW=(1.2−0.8)×I=0.4 I when the cross-over is eliminated.

The phenomenon of cross-over, in which methanol of the anode is not decomposed but is passed through the Nafion membrane as a polymer electrolyte membrane and thus moves toward the cathode, may be prevented through an anodic reaction during the movement of methanol in the polymer electrolyte.

The catalyst, which is able to decompose methanol, is typically exemplified by platinum. FIG. 1 is a schematic view illustrating the platinum particles dispersed in the Nafion polymer electrolyte to cause the anodic reaction in the electrolyte so as to decrease the cross-over.

That is, the catalyst, such as platinum, is dispersed in conventional polymeric Nafion in the form of nanoparticles, so that it enables the efficient movement of six hydrogen ions produced by the anodic reaction in the anode and also causes methanol, which moves to the cathode due to the cross-over without the anodic reaction, to be subjected to the anodic reaction, thus preventing cross-over. Ultimately, the difference in voltage between the anode and the cathode becomes close to a theoretical value, resulting in maximum energy density.

Moreover, in order to prevent the poisoning of the platinum catalyst in Nafion by carbon, platinum, in the form of an alloy with ruthenium, that is, a platinum-ruthenium alloy catalyst, may be dispersed in Nafion in the form of nanoparticles.

### SUMMARY OF THE INVENTION

Accordingly, the present invention has been made keeping in mind the above problems related to conventional Nafion membranes in the prior art, and an object of the present invention is to provide an IPMC electrolyte for a fuel cell, which can decrease the phenomenon of cross-over of methanol, and a method of preparing the same.

In order to accomplish the above object, the present invention provides an IPMC electrolyte for a fuel cell, in which metal nanoparticles are dispersed in a polymer material, and a method of preparing the same.

Specifically, the present invention provides a method of preparing an IPMC electrolyte for a fuel cell, comprising pretreating a Nafion membrane at S1 and dispersing a metal catalyst in the pretreated Nafion membrane at S2.

As the metal catalyst, any metal catalyst may be used without limitation as long as it is typically known in the field of fuel cells. Preferably, platinum or a platinum-ruthenium (Pt—Ru) alloy is useful.

Further, the process of dispersing the metal catalyst in the pretreated Nafion membrane may be performed using a liquid phase process or a vacuum drying process, such as sputtering or vacuum evaporation.

### BRIEF DESCRIPTION OF THE DRAWINGS

FIG. 1 is a schematic view illustrating the IPMC electrolyte suitable for decreasing cross-over, according to the present invention;

FIGS. 2A and 2B are flowcharts sequentially illustrating the process of pretreating the Nafion membrane and the process of dispersing a metal catalyst layer in the pretreated Nafion membrane, respectively, in the preparation of the Nafion membrane of the present invention; and

FIG. 3 is a scanning electron micrograph illustrating the section of the IPMC electrolyte of the present invention.

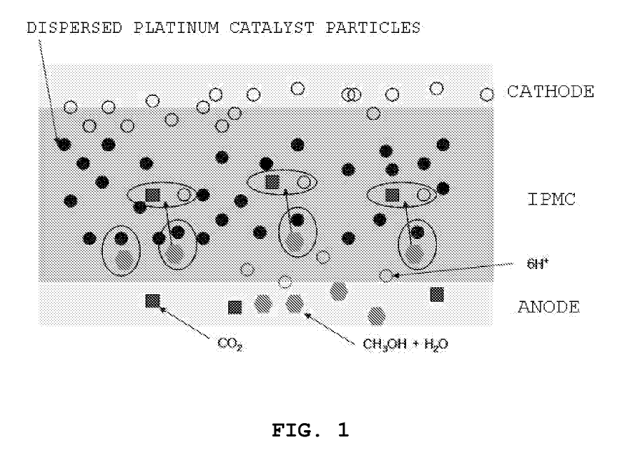

### DESCRIPTION OF THE PREFERRED EMBODIMENTS

Hereinafter, a detailed description will be given of the present invention, with reference to the appended drawings.

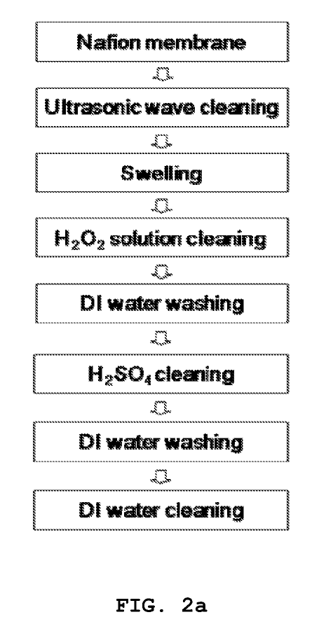

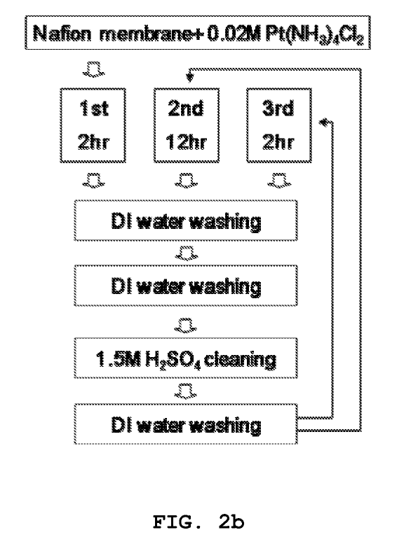

FIG. 2A illustrates the process of pretreating a Nafion membrane at S1, comprising (1) scratching the surface of the Nafion membrane with abrasive paper (#400˜600) to increase the surface adhesion of the membrane, (2) removing the pieces of Nafion from the surface of the membrane using an ultrasonic cleaner, (3) immersing the Nafion membrane in deionized water for 24 hours to swell it so as that ions efficiently permeate thereinto, (4) removing organic material from the surface of the Nafion membrane using a 3% aqueous hydrogen peroxide solution, (5) cleaning the Nafion membrane with deionized water and removing inorganic material from the surface of the membrane using a sulfuric acid solution, to thus substitute the Nafion membrane with a hydrogen ion (H⁺), and (6) washing the Nafion membrane with deionized water.

FIG. 2B illustrates the process of dispersing a platinum catalyst in the pretreated Nafion membrane at S2, comprising (1) immersing the pretreated Nafion membrane in a solution of Pt(NH₃)₄Cl₂ to thus ion-exchange H⁺ of the pretreated Nafion membrane with [Pt(NH₃)_{4]}²⁺, (2) immersing the ion-exchanged Nafion membrane in a solution of NH₄OH and NaBH₄ to reduce it with platinum metal in order to diffuse a platinum layer in the Nafion membrane, (3) boiling the reduced Nafion membrane using a H₂SO₄ solution to remove unreacted reductant, and washing it with deionized water, and (4) repeating the procedures (1) to (3) three times.

A better understanding of the present invention may be obtained by way of the following examples and test example, which are set forth to illustrate, but are not to be construed to limit, the present invention.

### EXAMPLE 1

### Formation of Nafion Membrane

The surface of a typical Nafion membrane (Nafion®) was scratched using #500 abrasive paper so as to increase the adhesive force of the surface, after which the pieces of Nafion were removed from the surface thereof using an ultrasonic cleaner.

The Nafion membrane was immersed in deionized water for 24 hours and thus swollen. Then, the Nafion membrane was treated using 3% hydrogen peroxide to thus remove organic material from the surface thereof, and then cleaned with deionized water.

Further, the Nafion membrane was treated using a sulfuric acid solution to thus remove inorganic material from the surface thereof, and then the surface thereof was substituted with a hydrogen ion.

The Nafion membrane, having the surface substituted with the hydrogen ion, was washed clean with deionized water.

### EXAMPLE 2

### Formation of Nano-Platinum Layer in Nafion Membrane

The Nafion membrane, having the surface substituted with the hydrogen ion, obtained in Example 1, was immersed in a 0.02 M Pt(NH₃)₄Cl₂ solution for 2 hours to thus adsorb a platinum salt thereon, and was then washed with deionized water.

The Nafion membrane having the platinum salt adsorbed thereon was added with a solution of 30% NH₄OH and 2% NaBH₄, thus reducing the platinum salt into platinum metal.

The Nafion membrane having the platinum metal layer therein was placed into a 1.5 M aqueous sulfuric acid solution and boiled, to thus remove unreacted reductant, and was then washed with deionized water. Subsequently, the membrane was immersed again in a 0.02 M solution for 12 hours, and subsequent processes were repeated.

Finally, the Nafion membrane was immersed again in a 0.02 M Pt(NH₃)₄Cl₂ solution for 2 hours, and subsequent processes were repeated, thus forming a nano-platinum layer in the Nafion membrane.

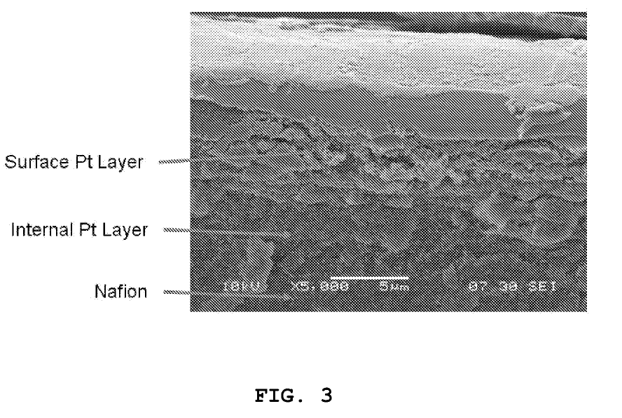

The section of the IPMC electrolyte in which the nano-platinum layer was formed in the Nafion membrane was observed using a scanning electron microscope. The result is shown in FIG. 3.

As shown in FIG. 3, the platinum nanoparticles could be seen to be uniformly dispersed from the surface of the Nafion membrane to the middle portion thereof.

### TEST EXAMPLE

### Evaluation of Change in Potential

In order to measure the open-circuit voltage of the IPMC electrolyte thus formed, an anode and a cathode were disposed on both surfaces of the IPMC, and high-temperature compression was conducted at 140° C. at a pressure of 200 kg/cm² for 2 min, thus fabricating an electrolyte-electrode assembly.

The electrolyte-electrode assembly was mounted to a cell frame for the measurement of a half cell. While supplying an aqueous methanol solution to the anode, the difference in potential from that of an Ag/AgCl standard electrode was measured to evaluate changes in potential of the cathode before and after the supply of the aqueous methanol solution.

After 10 min of the supply of the aqueous methanol solution, the open-circuit voltage of the cathode was compared with the value of a typical Nafion membrane. The typical Nafion membrane electrolyte was determined to be about 0.7 V, whereas the IPMC electrolyte of the present invention was determined to be 1.0 V.

Consequently, the IPMC electrolyte of the present invention was confirmed to prevent a decrease in potential in the cathode due to cross-over.

As described hereinbefore, the present invention provides an IPMC electrolyte for a fuel cell. According to the present invention, the IPMC electrolyte can solve problems related to cross-over of a conventional Nafion membrane, so that the open-circuit voltage of an MDFC is increased and the output properties thereof are improved. Thus, the IPMC electrolyte of the present invention can be used as the polymer membrane for the MDFC.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An ionic polymer metal composite electrolyte for a fuel cell, in which nano and/or micro-metal particles are dispersed in a Nafion membrane.

2. The electrolyte as set forth in claim 1, wherein the metal comprises platinum or a platinum-ruthenium alloy.

3. A method of preparing an ionic polymer metal composite electrolyte for a fuel cell, comprising pretreating a Nafion membrane and dispersing a metal catalyst in the pretreated Nafion membrane.

4. The method as set forth in claim 3, wherein the pretreating the Nafion membrane is performed by:
(a) scratching a surface of the Nafion membrane with abrasive paper (#400˜600) to increase adhesive force of the surface of the Nafion membrane;
(b) removing pieces of the Nafion membrane from the surface of the Nafion membrane using an ultrasonic cleaner;
(c) immersing the Nafion membrane in deionized water for 24 hours to swell it so as to allow ions to efficiently permeate thereinto;
(d) removing organic material from the surface of the Nafion membrane using a 3% aqueous hydrogen peroxide solution;
(e) cleaning the Nafion membrane with deionized water and removing inorganic material from the surface of the Nafion membrane using a sulfuric acid solution, to thus substitute the Nafion membrane with a hydrogen ion (H⁺); and
(f) washing the Nafion membrane with deionized water.

5. The method as set forth in claim 3, wherein the dispersing the metal catalyst in the pretreated Nafion membrane is performed by:
(1) immersing the pretreated Nafion membrane in a solution of Pt(NH₃)₄Cl₂ to thus ion-exchange H⁺ of the pretreated Nafion membrane with [Pt(NH₃)₄]²⁺;
(2) immersing the ion-exchanged Nafion membrane in a solution of NH₄OH and NaBH₄ to reduce it with platinum metal to diffuse a platinum layer in the Nafion membrane;
(3) boiling the reduced Nafion membrane using an H₂SO₄ solution to remove unreacted reductant, and washing it with deionized water; and
(4) repeating steps (1) to (3) three times.

6. The method as set forth in claim 3, wherein the dispersing the metal catalyst in the pretreated Nafion membrane is performed using any one selected from among a liquid phase process, a sputtering process, and a vacuum evaporation process.

7. The method as set forth in claim 3, wherein the metal catalyst comprises platinum or a platinum-ruthenium alloy.
